(19) United States
(12) Patent Application Publication
(10) Pub. No.: US 2024/0252009 A1
(43) Pub. Date: Aug. 1, 2024

(54) HANDHELD ELECTRIC VACUUM

(71) Applicant: YAMABIKO CORPORATION, Tokyo (JP)

(72) Inventors: Tomohisa UMEKI, Tokyo (JP); Kenji Suzuki, Tokyo (JP)

(21) Appl. No.: 18/411,868

(22) Filed: Jan. 12, 2024

(30) Foreign Application Priority Data
Jan. 27, 2023 (JP) 2023-010960

(51) Int. Cl. A47L 9/32; A47L 5/24; A47L 9/24; A47L 9/28

(52) U.S. Cl. CPC A47L 9/322; A47L 5/24; A47L 9/242; A47L 9/248; A47L 9/2857; A47L 9/2884

(57) ABSTRACT

Provided is a handheld electric vacuum capable of improving the operability and workability while reducing the likelihood of the structure becoming more complicated or larger by optimizing the layout configuration around a handle, including a blower fan, a casing, and a battery. The blower fan is inclined forwardly along a bending portion and disposed on the base end side of the bending portion provided at the base end of the pipe. In addition, an opposing portion (vertical side portion) of the handle incorporating the battery, facing the blower fan is inclined (inclined backwardly) oppositely to the blower fan. The upper length (near a grip portion) of a space of the handle formed on the base end side of the blower fan is greater than the lower length thereof.

### CROSS REFERENCE TO RELATED APPLICATIONS

The present application claims priority from Japanese patent application JP 2023-010960 filed on Jan. 27, 2023, the entire content of which is hereby incorporated by reference into this application.

### BACKGROUND

### Technical Field

The present invention relates to a handheld electric vacuum configured to perform sucking work to suck in dust and debris.

### Background Art

There is known a conventional technique of a vacuum used in work to suck in and collect dust and debris such as fallen leaves (hereinafter referred to as “sucking work”) disclosed, for example, in JP 2022-114780 A. The conventional vacuum disclosed in JP 2022-114780 A is a handheld electric vacuum configured to perform sucking work, including: a pipe including a suction port at one end and a discharge port at the other end; a blower fan provided outside the pipe and driven by an electric motor; a handle provided outside the pipe and near the discharge port in a longitudinal direction of the pipe, and configured to be held by a hand; and an ejector provided near the suction port in the longitudinal direction of the pipe, and configured to feed pressurized wind generated by the blower fan into the pipe from around the pipe, and to eject the pressurized wind to the discharge port. A battery configured to supply the electric motor with power is attached to the outside of the pipe near the discharge port. The handle is located between a center of gravity of the battery and a center of gravity of the blower fan.

In the above-described handheld electric vacuum, the pressurized wind ejected from the ejector passes through the inside of the pipe along the inner surface of the pipe and is ejected to the discharge port. This pressurized wind causes the pressure inside the pipe to be lowered, thereby to generate suction flow (negative pressure) in the pipe from the suction port toward the discharge port. Accordingly, the handheld electric vacuum sucks in dust and so forth into the pipe from the suction port provided at one end of the pipe, and discharges the sucked objects such as the dust from the discharge port provided at the other end of the pipe to collect the sucked objects in a collector such as a bag attached to the discharge port.

### SUMMARY

In the conventional handheld electric vacuum disclosed in JP 2022-114780 A, a blower fan and a fan casing (hereinafter referred to simply as a casing) of the blower fan formed as a volute, which are heavy in weight, are disposed along the periphery of the pipe at the positions far from the handle to be held by a hand. Thus, the conventional vacuum may put a large load on an operator during work, reduce operability, and the like.

Then, the blower fan and the casing that are heavy in weight may be disposed at the positions near the handle to be held by a hand (see, for example, US 2021/0282339 A). However, placing the major components, such as the blower fan, the casing, and the battery, intensively near the handle may narrow the space around the grip portion (i.e., portion gripped by an operator for operation) of the handle, causing a lower operability and workability. In addition, the structure may become more complicated or larger to ensure a space around the grip portion of the handle (see, for example, US 2021/0282339 A). In particular, in an attempt to ensure a larger space around the grip portion of the handle, the heavy components such as the blower fan and the battery may be disposed at the positions spaced from the handle. However, this causes another issue that the operation may not be performed in good balance.

The present invention has been made in view of the above issue, and it is an object of the present invention to provide a handheld electric vacuum capable of improving the operability and workability while reducing the likelihood of the structure becoming more complicated or larger by optimizing the layout configuration around the handle, including the blower fan, the casing, and the battery.

To address the above issue, the handheld electric vacuum according to the present invention is a handheld electric vacuum configured to perform sucking work, including: a pipe including a suction port at a front end and a discharge port at a base end; a blower fan provided outside the pipe and driven by an electric motor; a pressure flow path provided outside the pipe, and configured to feed pressurized wind generated by the blower fan into the pipe from around the pipe near the suction port, and to eject the pressurized wind to the discharge port; a handle provided outside the pipe and near the discharge port of the pipe, and configured to be held by a hand; and a battery configured to supply the electric motor with power. The pipe extends along an axis from the front end to the base end and includes at the base end a bending portion inclined with respect to the axis. The blower fan is inclined forwardly along the bending portion and disposed on a base end side of the bending portion. The handle is disposed between a lower side and an upper side of the blower fan so as to form a space on a base end side of the blower fan. The battery is attached to an opposing portion on a base end side of the handle, the opposing portion facing the blower fan with the space interposed therebetween. The opposing portion of the handle and the battery attached to the opposing portion are inclined oppositely to the blower fan with respect to the axis, and an upper length of the space of the handle is greater than a lower length thereof.

In a preferred aspect, the handle includes a lower side portion extending from the lower side of the blower fan to a base end side of the handheld electric vacuum, an upper side portion extending from the upper side of the blower fan to the base end side of the handheld electric vacuum, and a vertical side portion extending from a base end portion of the lower side portion to a base end portion of the upper side portion to form the opposing portion facing the blower fan, and the lower side portion, the upper side portion, and the vertical side portion form the space on the base end side of the blower fan.

In another preferred aspect, an upper portion of the handle and the pressure flow path are continuously formed.

In further preferred aspect, the upper portion of the handle and the pressure flow path are continuously formed in a straight line shape along the axis.

In still another preferred aspect, the upper portion of the handle includes a curved portion projecting upward, and a front end of the curved portion of the upper portion of the handle and the pressure flow path are continuously formed in a straight line shape along the axis.

In yet another preferred aspect, the battery is attached to the opposing portion of the handle by sliding from an upper side to a lower side with an inclination opposite to an inclination of the blower fan with respect to the axis.

In yet another preferred aspect, a control board of the blower fan is housed in a lower portion of the handle.

In yet another preferred aspect, an operating member is provided in an upper portion of the handle and is configured to adjust a rotating speed of the electric motor of the blower fan.

In yet another preferred aspect, a connecting wall connecting the pressure flow path and the pipe includes a through-hole that allows a portion of the pressure flow path to be used as a sub-handle to be held by a hand.

In yet another preferred aspect, the pressure flow path extends from the upper side of the blower fan to near the suction port of the pipe and is inclined with respect to the axis so as to come closer to the pipe from the base end to the front end; and the connecting wall connecting a lower side of the pressure flow path and an upper side of the pipe includes the through-hole.

According to the present invention, the blower fan is inclined forwardly along the bending portion and disposed on the base end side of the bending portion provided at the base end of the pipe. In addition, the opposing portion (vertical side portion) of the handle incorporating the battery, facing the blower fan is inclined (inclined backwardly) oppositely to the blower fan. The upper length (near the grip portion) of the space of the handle formed on the base end side of the blower fan is greater than the lower length thereof. Accordingly, even when the blower fan, the casing, the battery, and the like, which are heavy in weight, are placed near the handle, it is possible to ensure the space for the grip portion of the handle without causing the structure to become more complicated or larger. Thus, it is possible to improve the operability and workability while reducing the likelihood of the structure becoming more complicated or larger.

### BRIEF DESCRIPTION OF THE DRAWINGS

FIG. 1 is an external perspective view of a handheld electric vacuum according to an embodiment of the present invention as viewed obliquely from the front side;

FIG. 2 is an external perspective view of the handheld electric vacuum according to the embodiment of the present invention as viewed obliquely from the back side;

FIG. 3 is a side view of the handheld electric vacuum according to the embodiment of the present invention;

FIG. 4 is a top view of the handheld electric vacuum according to the embodiment of the present invention;

FIG. 5 is a bottom view of the handheld electric vacuum according to the embodiment of the present invention;

FIG. 6 is a vertical cross-sectional view of the handheld electric vacuum according to the embodiment of the present invention (a sucking state: a vacuum mode); and

FIG. 7 is a vertical cross-sectional view of the handheld electric vacuum according to the embodiment of the present invention (a blowing state: a blower mode).

### DETAILED DESCRIPTION

Hereinafter, an embodiment of the present invention will be described with reference to the drawings. In the following description, the same reference numbers in the different drawings indicate the same functional sections, and therefore repeated description for each of the drawings will be omitted.

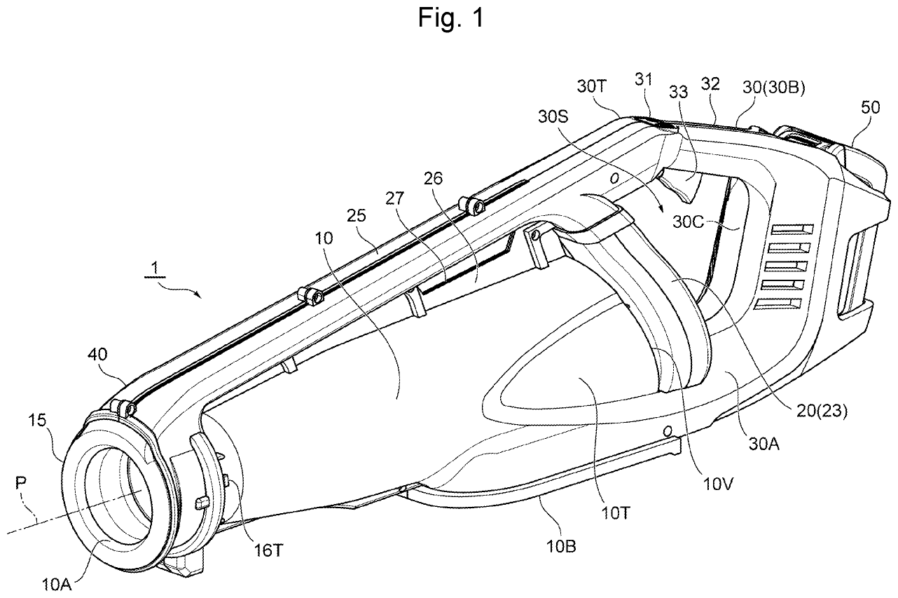

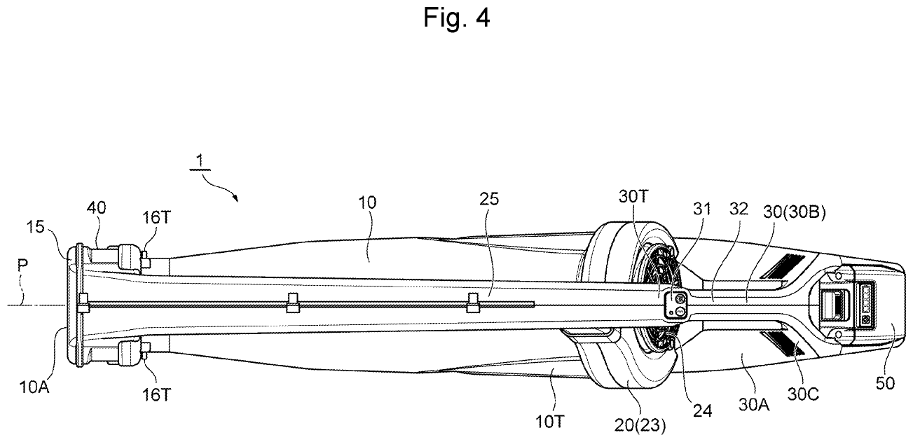

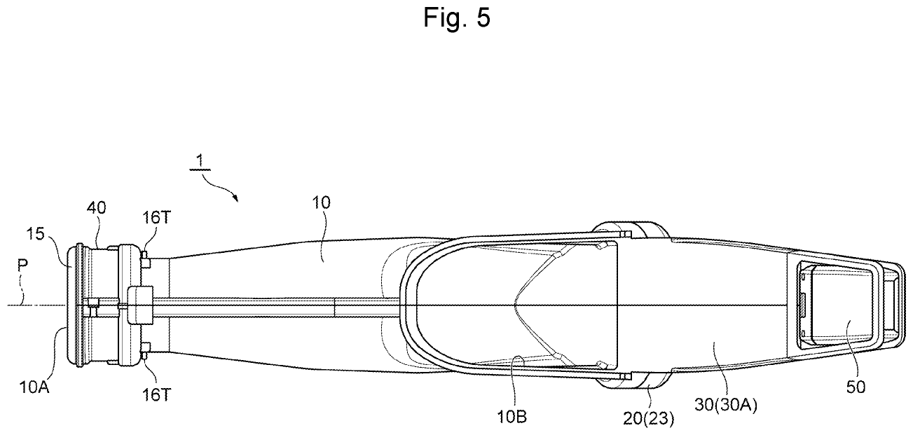

As shown in FIG. 1 to FIG. 7, a handheld electric vacuum (hereinafter this may be simply referred to as a vacuum) 1 of the present embodiment is a handheld working machine for sucking work, and includes a pipe 10 configured to suck in dust and debris, a blower fan 20, a handle 30, and a nozzle 40.

The pipe 10 includes a suction port 10A at one end (front end) and a discharge port 10B at the other end (base end), and is configured to suck in objects from the suction port 10A into the pipe 10 and discharge the sucked objects from the discharge port 10B. During the sucking work, a collecting bag and so forth (not shown) is attached to the discharge port 10B to collect the sucked objects.

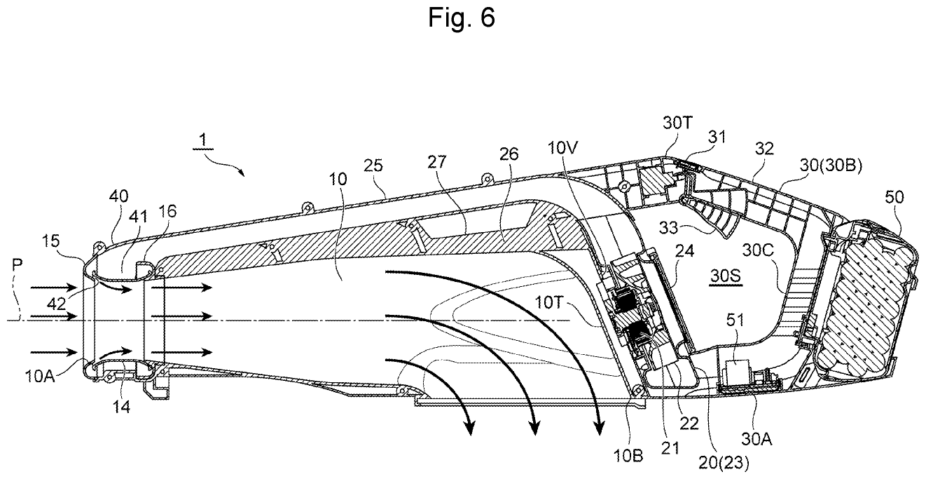

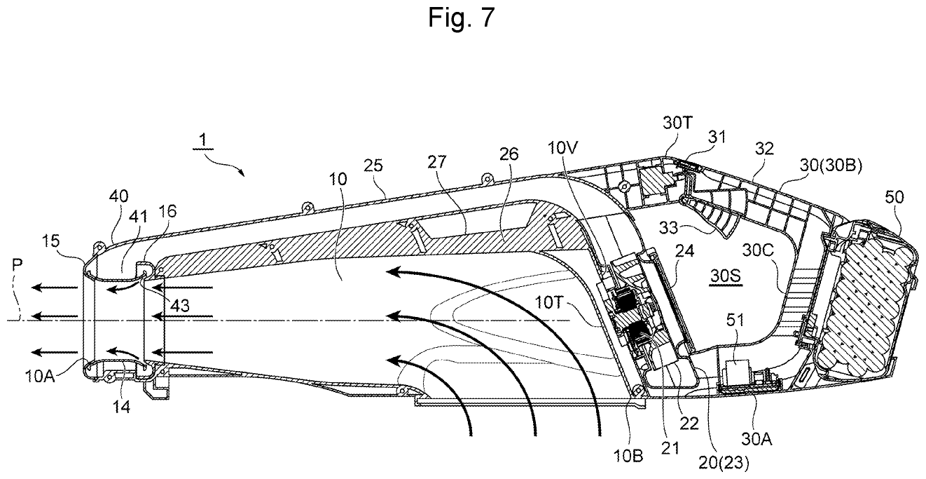

The inside diameter of the pipe 10 over the entire length of the pipe 10 is equal to or greater than the bore of the suction port 10A (see FIG. 6 and FIG. 7). By this means, all the objects sucked from the suction port 10A into the pipe 10 are smoothly fed to the discharge port 10B with a little resistance.

In the present embodiment, the pipe 10 includes a bending portion 10T at the base end. That is, the pipe 10 extends along a central axis P (axis) of the pipe 10 from the front end including the suction port 10A to the base end including the bending portion 10T. The bending portion 10T is inclined (inclined forwardly) with respect to the central axis P of the pipe 10, thereby to form the entire pipe in an L-shape. The other opening (herein, the lower end opening) of the bending portion 10T is the discharge port 10B. The suction port 10A at the front end is open toward the front, and the discharge port 10B at the base end is open toward the bottom. In addition, in the present embodiment, the base end of the pipe 10 (or the bending portion 10T thereof) includes a plane 10V that is inclined (inclined forwardly) with respect to the central axis P of the pipe 10 along the bending portion 10T. This plane 10V is a surface on which the blower fan 20 is placed, which will be described later.

The blower fan 20 is provided outside the pipe 10. More specifically, the blower fan 20 is inclined forwardly along the bending portion 10T and disposed in proximity to the base end side of the bending portion 10T (or on the placement surface 10V thereof) formed at the base end of the pipe 10. With reference to FIG. 6 and FIG. 7, the blower fan 20 is a centrifugal blower fan driven by a built-in electric motor 21, and is disposed such that the driving shaft of the electric motor 21 is coaxial with the rotating shaft of a fan 22 with a slight inclination with respect to the central axis P of the pipe 10. A casing 23 of the blower fan 20 formed as a volute is disposed along the placement surface 10V of the pipe 10. Wind sucked from a sucking portion 24 by the rotation of the fan 22 passes through the casing 23 and is fed, as compressed air, into a pressure flow path 25 disposed outside of the pipe 10. Here, a compressor may be adopted instead of the illustrated centrifugal blower fan, as long as it can feed the compressed air.

The pressure flow path 25 is provided outside the pipe 10. More specifically, the pressure flow path 25 is disposed on the upper side of the pipe 10. The pressure flow path 25 is configured to feed pressurized wind generated by the blower fan 20 to the nozzle 40 provided near the suction port 10A of the pipe 10 to feed the pressurized wind generated by the blower fan 20 into the pipe 10 from around the pipe 10 and eject the pressurized wind to the discharge port 10B. In the present embodiment, the pressure flow path 25 extends substantially linearly from the upper side of the casing 23 (blower fan 20) to near the suction port 10A of the pipe 10 and is inclined (inclined forwardly) with respect to the central axis P so as to come closer to the pipe 10 as it approaches the front (from the base end to the front end).

The handle 30 to be held by a hand is provided outside the pipe 10 and near the discharge port 10B in the longitudinal direction of the pipe 10. In the present embodiment, the handle 30 has a lateral U-shape, and is disposed between the upper side of the casing 23 (blower fan 20), that is, the base end of the pressure flow path 25, and the lower side of the casing 23 (blower fan 20). With this shape, the handle 30 includes a space 30S having a predetermined size on the base end side of the blower fan 20 (or the sucking portion 24 thereof).

More specifically, the handle 30 includes a lower side portion 30A extending from the lower side of the casing 23 (blower fan 20) to the base end side of the handheld electric vacuum 1, an upper side portion 30B extending from the upper side of the casing 23 (blower fan 20) to the base end side of the handheld electric vacuum 1, and a vertical side portion 30C extending from the base end portion of the lower side portion 30A to the base end portion of the upper side portion 30B to connect the lower side portion 30A and the upper side portion 30B. The space 30S defined (surrounded) by the lower side portion 30A, the upper side portion 30B, and the vertical side portion 30C is formed on the base end side of the blower fan 20 (or the sucking portion 24 thereof). The vertical side portion 30C on the base end side of the handle 30 is disposed to substantially face the blower fan 20 with the space 30S interposed therebetween (opposing portion).

With reference to FIG. 6 and FIG. 7, the lower side portion 30A of the handle 30 serves as a housing of a control board (also referred to as a drive circuit) 51 of the blower fan 20. In other words, the control board 51 of the blower fan 20 is housed in the lower side portion 30A of the handle 30.

The upper side portion 30B of the handle 30 is a grip 32 held by mainly an operator. A switch 31 is provided on the outside (the upper side) of the grip 32 and is configured to switch on and off the electric motor 21 for driving the blower fan 20. An operating lever 33 is provided on the inside (the lower side) of the grip 32 as an operating member configured to adjust the rotating speed of the electric motor 21 of the blower fan 20. In the present embodiment, the upper side portion 30B of the handle 30 has a mountain shape including a curved portion 30T projecting upward near the center in the longitudinal direction. The switch 31 and the operating lever 33 are provided near this curved portion 30T, on the upper and lower sides, respectively.

In the present embodiment, the upper side portion 30B of the handle 30 is formed in a substantially straight line shape so as to be continuous with the pressure flow path 25 provided on the upper side of the pipe 10 along the central axis P of the pipe 10. More specifically, the front end (forwardly-inclined portion) of the curved portion 30T in the upper side portion 30B of the handle 30 and the pressure flow path 25 are continuously formed in a straight line shape along the central axis P of the pipe 10. The switch 31 and the operating lever 33 are provided at the base end (backwardly-inclined portion) of the curved portion 30T in the upper side portion 30B of the handle 30. Note that the base end (backwardly-inclined portion) of the curved portion 30T in the upper side portion 30B of the handle 30 is slightly thinner than the front end (forwardly-inclined portion) of the curved portion 30T. This is because the front end of the curved portion 30T has the pressure flow path 25 formed therein, whereas the base end of the curved portion 30T does not have the pressure flow path 25 formed therein. If a sufficient volume of air to be fed to the front can be ensured, the front end and the base end of the curved portion 30T may have substantially the same thickness. This can avoid the entire structure from becoming larger and further improve the entire appearance.

A battery 50 configured to supply the electric motor 21 with power is attached to the vertical side portion 30C of the handle 30. In the present embodiment, the base end side of the vertical side portion 30C of the handle 30 serves as a housing of the battery 50. In the present embodiment, the vertical side portion 30C of the handle 30 is disposed so as to substantially face the blower fan 20 (or the bending portion 10T) and is inclined (inclined backwardly) oppositely to the blower fan 20 (or the bending portion 10T) with respect to the central axis P of the pipe 10. The battery 50 is configured to be attached to the vertical side portion 30C of the handle 30 on the base end side (housing) by sliding from the upper side to the lower side with an inclination with respect to the central axis P of the pipe 10, and is inclined (inclined backwardly) oppositely to the blower fan 20 (or the bending portion 10T) with respect to the central axis P of the pipe 10.

As described above, the vertical side portion 30C of the handle 30 and the battery 50 attached to the vertical side portion 30C are inclined (inclined backwardly) oppositely to the blower fan 20 (or the bending portion 10T) with respect to the central axis P of the pipe 10. Thus, the upper length (near the upper side portion 30B or grip 32) of the space 30S of the handle 30 is greater than the lower length (near the lower side portion 30A) thereof. Accordingly, even when the major components, such as the blower fan 20, the casing 23, and the battery 50, are placed intensively near the handle 30, it is possible to ensure the space for the grip portion of the handle 30 and the space around it, without causing the structure to become more complicated or larger. In addition, since the heavy components are arranged substantially the same distance from the grip portion in the front and back directions, the balance is always maintained even when the machine position during work changes frequently.

In addition, in the present embodiment, a connecting wall 26 connecting the pipe 10 and the pressure flow path 25 provided outside the pipe 10 is provided therebetween. More specifically, the connecting wall 26 is provided along the central axis P of the pipe 10 to connect the upper side of the pipe 10 and the lower side of the pressure flow path 25. This connecting wall 26 (or its portion near the handle 30) includes a rectangular through-hole 27. With this through-hole 27, the portion of the pressure flow path 25 above the through-hole 27 can be used as a sub-handle to be held by a hand.

The nozzle 40 is provided near the suction port 10A in the longitudinal direction of the pipe 10, and configured to feed pressurized wind generated by the blower fan 20 from around the pipe 10 into the pipe 10 and eject the pressurized wind to the discharge port 10B. The pressurized wind is ejected from the nozzle 40 to the discharge port 10B along the inner surface of the pipe 10. This pressurized wind causes the pressure inside the pipe 10 to be lowered, thereby to generate suction flow in the pipe 10 from the suction port 10A toward the discharge port 10B.

The nozzle 40 includes a circular flow path 41 protruding outward of the pipe 10. The circular flow path 41 is provided circumferentially around the central axis P of the pipe 10. The pressurized wind generated by the blower fan 20 is introduced into the circular flow path 41 via the pressure flow path 25. The pressure flow path 25 is connected above the circular flow path 41.

The circular flow path 41 includes an ejection port 42 that is an opening configured to communicate with the inside of the pipe 10 over the entire circumference around the central axis P of the pipe 10. The pressurized wind is ejected through the ejection port 42 along the inner surface of the pipe 10 (FIG. 6). When ejected to the pipe 10 through the ejection port 42, the pressurized wind may contain a circumferential component. By this means, swirling flow along the inner wall of the pipe 10 is added, thereby to increase suction force near the inner wall of the pipe 10.

In the present embodiment, the nozzle 40 includes an inner pipe 14 inserted into the inside of the circular flow path 41 of the pipe 10. In addition, the nozzle 40 includes a turn portion 15 disposed on the front end side (i.e., the front end portion of the pipe 10) of the circular flow path 41 of the pipe 10, (in an annular shape) around the front end portion of the inner pipe 14. The turn portion 15 is formed in an annular shape around the central axis P of the pipe 10 such that it turns from the outside to the inside of the front end portion of the inner pipe 14 and toward the base end side. In the present embodiment, the turn portion 15 basically includes a (cornerless) continuous curved surface. The inside (inner circumferential surface) of the turn portion 15 is the suction port 10A of the pipe 10, and a gap formed between the turn portion 15 and the inner pipe 14 (or the front end portion thereof) is the ejection port 42 configured to communicate with (i.e., open to) the inside of the pipe 10 in the circular flow path 41. By this means, the pressurized wind is fed from the circular flow path 41 of the nozzle 40 toward the outside of the inner pipe 14, then the pressurized wind fed to the outside of the inner pipe 14 passes between the turn portion 15 and the inner pipe 14 and turns toward the base end at around the front end portion of the inner pipe 14, and is ejected through the ejection port 42 to the discharge port 10B at the base end along the inside (inner circumferential surface) of the inner pipe 14.

The vacuum 1 configured as described above forms suction flow in the pipe 10 from the suction port 10A at one end to the discharge port 10B at the other end. In addition, there is no reduced diameter portion in the pipe 10, and therefore the pipe 10 maintains its inside diameter which is sufficient to allow large sucked objects to pass therethrough along the longitudinal direction.

By this means, the objects sucked by the vacuum 1 from the suction port 10A into the pipe 10 can be efficiently guided to the discharge port 10B, and even when large objects are sucked from the suction port 10A, the sucked objects can be smoothly guided to the discharge port 10B without clogging or the like, and then can be collected.

In addition, the vacuum 1 of the present embodiment can switch between sucking work (also referred to as a vacuum mode) and blowing work (also referred to as a blower mode) by incorporating a simple switching mechanism into the above-described nozzle 40.

As the switching mechanism, the inner pipe 14 is slidably disposed relative to the circular flow path 41. In addition, the nozzle 40 includes a turn portion 16 disposed on the base end side of the circular flow path 41 of the pipe 10, (in an annular shape) around the base end portion of the inner pipe 14. The turn portion 16 is formed in an annular shape around the central axis P of the pipe 10 such that it turns from the outside to the inside of the base end portion of the inner pipe 14 and toward the front end side. In the present embodiment, the turn portion 16 basically includes a (cornerless) continuous curved surface. The inside (inner circumferential surface) of the turn portion 16 is formed to be smoothly continuous to the inner wall of the pipe 10. According to the slide of this inner pipe 14, the opposite end portions of the inner pipe 14 come into contact with or are separated from the turn portions 15, 16 (the turn portions 15, 16 provided at the opposite end portions of the nozzle 40 (or the circular flow path 41 thereof)) provided so as to face the opposite end portions of the inner pipe 14. With this configuration, the vacuum 1 of the present embodiment switches between the discharge port 10B and the suction port 10A to which the pressurized wind fed by the nozzle 40 is ejected.

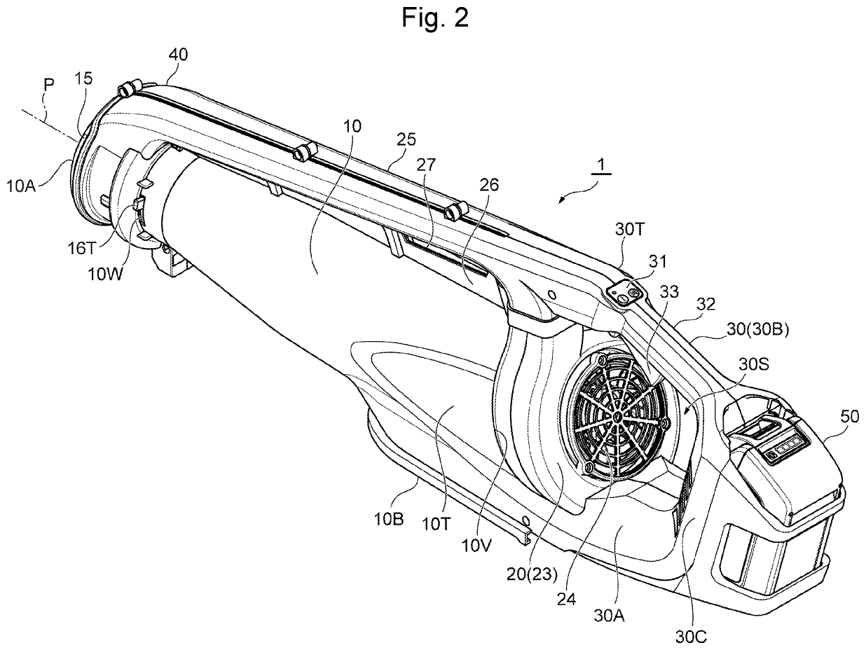

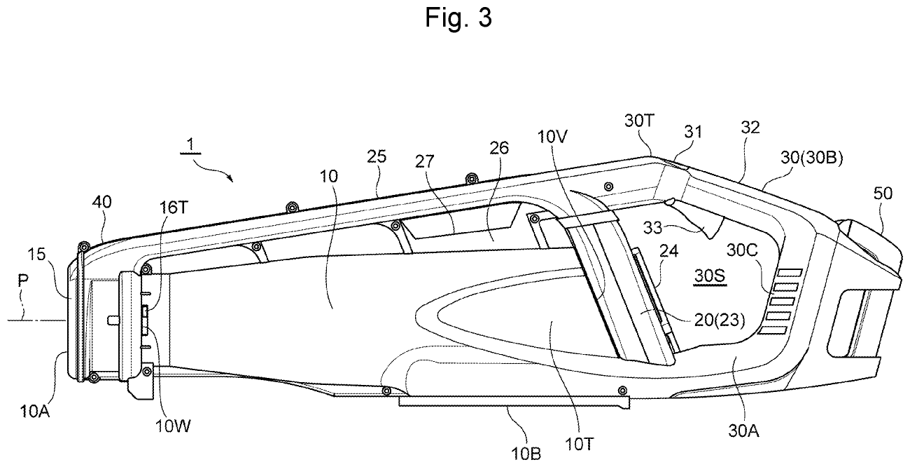

In the present embodiment, the turn portion 16 provided in the base end portion of the nozzle 40 (or the circular flow path 41 thereof) is configured to be rotatable about the central axis P of the pipe 10. In other words, the turn portion 16 is housed in the pipe 10 so as to be rotatable about the central axis P of the pipe 10. The front end portion of the turn portion 16 includes, in its inner circumferential portion, a helical groove, and the base end portion of the inner pipe 14 includes, in its outer circumferential portion, a projection that fits to the helical groove. The helical groove of the turn portion 16 and the projection of the inner pipe 14 form a cam mechanism that slides the inner pipe 14 relative to the circular flow path 41 according to the rotation of the turn portion 16. The turn portion 16 includes, on its periphery, an operating projection 16T that projects beyond an opening 10W circumferentially extending in the pipe 10 to allow the turn portion 16 to rotate relative to the pipe 10 (see, in particular, FIG. 2 and FIG. 3).

Note that the sliding configuration of sliding the inner pipe 14 relative to the circular flow path 41 is not limited to the illustrated example.

When the inner pipe 14 is slid toward the base end, the base end portion of the inner pipe 14 comes into close contact with (i.e., hermetically contacts) the turn portion 16, the base end of the circular flow path 41 is closed, the front end portion of the inner pipe 14 is separated from the turn portion 15, and as described above, a gap formed between the turn portion 15 and the inner pipe 14 (or the front end portion thereof) becomes the ejection port 42 configured to communicate with (i.e., open to) the inside of the pipe 10 in the circular flow path 41. The pressurized wind is ejected from the ejection port 42 along the inner surface of the pipe 10 (FIG. 6).

Meanwhile, when the inner pipe 14 is slid toward the front end, the front end portion of the inner pipe 14 comes into close contact with (i.e., hermetically contacts) the turn portion 15, the front end of the circular flow path 41 is closed, the base end portion of the inner pipe 14 is separated from the turn portion 16, and as described later, a gap formed between the turn portion 16 and the inner pipe 14 (or the base end portion thereof) becomes an ejection port 43 configured to communicate with (i.e., open to) the inside of the pipe 10 in the circular flow path 41. The pressurized wind is ejected from the ejection port 43 to the front end (suction port 10A) (FIG. 7).

FIG. 6 shows the switched state for the sucking work as already described. In this state, the inner pipe 14 is slid toward the base end, the base end portion of the inner pipe 14 is in contact with the turn portion 16 provided on the base end side of the circular flow path 41, and the front end portion of the inner pipe 14 is separated from the turn portion 15 provided on the front end side of the circular flow path 41. Accordingly, the base end of the circular flow path 41 is closed, and the pressurized wind is fed from the circular flow path 41 to the outside of the inner pipe 14, then passes between the turn portion 15 provided on the front end side of the circular flow path 41 and the inner pipe 14, turns toward the base end at around the front end portion of the inner pipe 14, enters the pipe 10 through the ejection port 42, and is ejected to the discharge port 10B along the inner periphery of the inner pipe 14. In this state, the turn portion 15 provided on the front end side of the circular flow path 41, that is, the front end of the pipe 10, is the suction port 10A, and suction flow is formed in the pipe 10 from the front end portion toward the base end portion of the pipe 10.

On the other hand, FIG. 7 shows the switched state for the blowing work. In this state, the inner pipe 14 is slid toward the front end, the front end portion of the inner pipe 14 is in contact with the turn portion 15 provided on the front end side of the circular flow path 41, and the base end portion of the inner pipe 14 is separated from the turn portion 16 provided on the base end side of the circular flow path 41. Accordingly, the front end of the circular flow path 41 is closed, and the pressurized wind is fed from the circular flow path 41 to the outside of the inner pipe 14, then passes between the turn portion 16 provided on the base end side of the circular flow path 41 and the inner pipe 14, turns toward the front end at around the base end portion of the inner pipe 14, enters the pipe 10 through the ejection port 43, and is ejected to the front end (suction port 10A) along the inner periphery of the inner pipe 14. In this state, the turn portion 15 provided on the front end side of the circular flow path 41, that is, the front end of the pipe 10, serves as a blowing port, and discharge flow is formed in the pipe 10 from the base end to the front end of the pipe 10.

As described above, the vacuum 1 according to the present embodiment becomes a working machine serving as a vacuum and a blower by incorporating a simple switching mechanism. In other words, the vacuum 1 according to the present embodiment can switch between the vacuum and the blower by simple switching operation. When used to clean up fallen leaves in a wide area, for example, the vacuum 1 according to the present embodiment is switched to the blower to gather the fallen leaves spread on the ground to some extent, and then switched to the vacuum to suck in the gathered fallen leaves or the like. By this means, it is possible to allow efficient collecting work with a single machine.

As described above, the vacuum 1 according to the present embodiment is a handheld electric vacuum configured to perform sucking work, including the pipe 10 including the suction port 10A at the front end (one end) and the discharge port 10B at the base end (the other end); the blower fan 20 provided outside the pipe 10 and driven by the electric motor 21; the pressure flow path 25 provided outside the pipe 10 (from the blower fan 20 to near the suction port 10A), and configured to feed pressurized wind generated by the blower fan 20 into the pipe 10 from around the pipe 10 near the suction port 10A, and to eject the pressurized wind to the discharge port 10B; the handle 30 provided outside the pipe 10 and near the discharge port 10B of the pipe 10, and configured to be held by a hand; and the battery 50 configured to supply the electric motor 21 with power. The pipe 10 (axially) extends along the axis (central axis P) from the front end to the base end and includes at the base end the bending portion 10T (the other opening thereof being the discharge port 10B) inclined (inclined forwardly) with respect to the axis (central axis P). The blower fan 20 is inclined forwardly along the bending portion 10T and disposed on the base end side of the bending portion 10T (or on the placement surface 10V thereof). The handle 30 is disposed between the lower side and the upper side of the blower fan 20 so as to form the space 30S on the base end side of the blower fan 20. The battery 50 is attached (along the opposing portion) to the opposing portion (vertical side portion 30C) on the base end side of the handle 30, the opposing portion (vertical side portion 30C) facing the blower fan 20 with the space 30S interposed therebetween. The opposing portion of the handle 30 and the battery 50 attached to the opposing portion are inclined (inclined backwardly) oppositely to the blower fan 20 (the bending portion 10T) with respect to the axis (central axis P). The upper length (near the upper side portion 30B) of the space 30S of the handle 30 is greater than the lower length (near the lower side portion 30A) thereof.

The handle 30 includes the lower side portion 30A extending from the lower side of the blower fan 20 to the base end, the upper side portion 30B extending from the upper side of the blower fan 20 to the base end, and the vertical side portion 30C extending from the base end portion of the lower side portion 30A to the base end portion of the upper side portion 30B to form the opposing portion facing the blower fan 20. The lower side portion 30A, the upper side portion 30B, and the vertical side portion 30C form the space 30S on the base end side of the blower fan 20.

The upper portion (the upper side portion 30B) of the handle 30 and the pressure flow path 25 are continuously formed.

The upper portion (the upper side portion 30B) of the handle 30 and the pressure flow path 25 are continuously formed in a straight line shape along the axis (central axis P).

The upper portion (the central portion of the upper side portion 30B) of the handle 30 includes the curved portion 30T projecting upward, and the front end of the curved portion 30T of the upper portion (the upper side portion 30B) of the handle 30 and the pressure flow path 25 are continuously formed in a straight line shape along the axis (central axis P).

The battery 50 is attached to the opposing portion (the vertical side portion 30C) of the handle 30 by sliding from the upper side to the lower side with an inclination opposite to an inclination of the blower fan 20 (the bending portion 10T) with respect to the axis (central axis P).

The control board (drive circuit) 51 of the blower fan 20 is housed in the lower portion (the lower side portion 30A) of the handle 30.

The operating member (operating lever 33) is provided in the upper portion (the upper side portion 30B) of the handle 30 and is configured to adjust the rotating speed of the electric motor 21 of the blower fan 20.

The connecting wall 26 connecting the pressure flow path 25 and the pipe 10 includes the through-hole 27 that allows a portion of the pressure flow path 25 (above the through-hole 27) to be used as a sub-handle to be held by a hand.

The pressure flow path 25 extends from the upper side of the blower fan 20 to near the suction port 10A of the pipe 10 (above thereof) and is inclined (inclined forwardly) with respect to the axis (central axis P) so as to come closer to the pipe 10 from the base end to the front end. The connecting wall 26 connecting the lower side of the pressure flow path 25 and the upper side of the pipe 10 includes the through-hole 27.

According to the present embodiment, the blower fan 20 is inclined forwardly along the bending portion 10T and disposed on the base end side of the bending portion 10T provided at the base end of the pipe 10. The opposing portion (vertical side portion 30C) of the handle 30 incorporating the battery 50, facing the blower fan 20 is inclined (inclined backwardly) oppositely to the blower fan 20. The upper length (near the grip portion) of the space 30S of the handle 30 formed on the base end side of the blower fan 20 is greater than the lower length thereof. Accordingly, even when the blower fan 20, the casing 23, the battery 50, and the like, which are heavy in weight, are placed near the handle 30, it is possible to ensure the space for the grip portion of the handle 30 without causing the structure to become more complicated or larger. Thus, it is possible to improve the operability and workability while reducing the likelihood of the structure becoming more complicated or larger.

In addition, the pressure flow path 25 configured to feed pressurized wind generated by the blower fan 20 to the nozzle 40 and the upper portion (upper side portion 30B) of the handle 30 are continuously formed. Accordingly, it is possible to simplify the overall configuration or to reduce the number of components.

In addition, the connecting wall 26 connecting the pressure flow path 25 and the pipe 10 includes the through-hole 27 to allow a portion of the pressure flow path 25 (above the through-hole 27) to be used as a sub-handle to be held by a hand. Accordingly, it is possible to further reduce the load on the operator during work, and to further improve the operability.

Although the embodiment of the present invention has been described in detail above with reference to the drawings, specific structures are not limited thereto, and any design changes that fall within the spirit and scope of the present invention are encompassed by the scope of the present invention.

What is claimed is:

1. A handheld electric vacuum configured to perform sucking work, comprising:
a pipe including a suction port at a front end and a discharge port at a base end;
a blower fan provided outside the pipe and driven by an electric motor;
a pressure flow path provided outside the pipe, and configured to feed pressurized wind generated by the blower fan into the pipe from around the pipe near the suction port, and to eject the pressurized wind to the discharge port;
a handle provided outside the pipe and near the discharge port of the pipe, and configured to be held by a hand; and
a battery configured to supply the electric motor with power,
wherein:
the pipe extends along an axis from the front end to the base end and includes at the base end a bending portion inclined with respect to the axis;
the blower fan is inclined forwardly along the bending portion and disposed on a base end side of the bending portion;
the handle is disposed between a lower side and an upper side of the blower fan so as to form a space on a base end side of the blower fan;
the battery is attached to an opposing portion on a base end side of the handle, the opposing portion facing the blower fan with the space interposed therebetween; and
the opposing portion of the handle and the battery attached to the opposing portion are inclined oppositely to the blower fan with respect to the axis, and an upper length of the space of the handle is greater than a lower length thereof.

2. The handheld electric vacuum according to claim 1, wherein the handle includes a lower side portion extending from the lower side of the blower fan to a base end side of the handheld electric vacuum, an upper side portion extending from the upper side of the blower fan to the base end side of the handheld electric vacuum, and a vertical side portion extending from a base end portion of the lower side portion to a base end portion of the upper side portion to form the opposing portion facing the blower fan, and the lower side portion, the upper side portion, and the vertical side portion form the space on the base end side of the blower fan.

3. The handheld electric vacuum according to claim 1, wherein an upper portion of the handle and the pressure flow path are continuously formed.

4. The handheld electric vacuum according to claim 3, wherein the upper portion of the handle and the pressure flow path are continuously formed in a straight line shape along the axis.

5. The handheld electric vacuum according to claim 4, wherein the upper portion of the handle includes a curved portion projecting upward, and a front end of the curved portion of the upper portion of the handle and the pressure flow path are continuously formed in a straight line shape along the axis.

6. The handheld electric vacuum according to claim 1, wherein the battery is attached to the opposing portion of the handle by sliding from an upper side to a lower side with an inclination opposite to an inclination of the blower fan with respect to the axis.

7. The handheld electric vacuum according to claim 1, wherein a control board of the blower fan is housed in a lower portion of the handle.

8. The handheld electric vacuum according to claim 1, wherein an operating member is provided in an upper portion of the handle and is configured to adjust a rotating speed of the electric motor of the blower fan.

9. The handheld electric vacuum according to claim 1, wherein a connecting wall connecting the pressure flow path and the pipe includes a through-hole that allows a portion of the pressure flow path to be used as a sub-handle to be held by a hand.

10. The handheld electric vacuum according to claim 9, wherein:
the pressure flow path extends from the upper side of the blower fan to near the suction port of the pipe and is inclined with respect to the axis so as to come closer to the pipe from the base end to the front end; and
the connecting wall connecting a lower side of the pressure flow path and an upper side of the pipe includes the through-hole.
